(19) United States
(12) Patent Application Publication
(10) Pub. No.: US 2026/0172436 A1
(43) Pub. Date: Jun. 18, 2026

(54) SYSTEM FOR ANALYSIS OF ELECTRONIC COMMUNICATION SYSTEMS

(71) Applicant: Virtual Connect Technologies, Inc., Greenville, SC (US)

(72) Inventors: Benjamin Hathaway, Greenville, SC (US); David Setzer, Greenville, SC (US)

(73) Assignee: Virtual Connect Technologies, Inc., Greenville, SC (US)

(21) Appl. No.: 19/462,226

(22) Filed: Jan. 28, 2026

Related U.S. Application Data
(63) Continuation-in-part of application No. 17/883,741, filed on Aug. 9, 2022, now Pat. No. 12,004,049.

(51) Int. Cl. H04L 9/40; H04L 41/06

(52) U.S. Cl. CPC H04L 63/1425; H04L 41/06; H04L 63/1433

(57) ABSTRACT

A system for analyzing an electronic communication system is provided, comprising: computer readable instructions stored in a tangible medium; a data source module in communication with an electronic message system configured to receive data from distinct data sources including: static email configuration data, live organizational data providing real-time visibility into email traffic, external DMARC forensic data including authentication results and spoofing attempt information, and aggregate reports including third-party telemetry data; an analysis engine configured to receive and fuse data from the distinct sources into unified analysis, generate a dynamic security score, and provide continuous compliance validation for the email domain; wherein the analysis engine calculates a security score and generates human-readable reports summarizing historical configuration trends, threat activity, and the security score.

### RELATED APPLICATIONS

This application is a continuation-in-part of U.S. application Ser. No. 17/883,941 titled COMPUTERIZED SYSTEM FOR ANALYSIS AND OF ELECTRONIC COMMUNICATION SYSTEMS filed Aug. 2, 2022, which is hereby incorporated by reference in its entirety.

### BACKGROUND OF THE INVENTION

### 1) Field of the Invention

This system is directed to a computerized system for the testing, analysis, recommendations for improving security of transmitted electronic information from a sender to a recipient including strengths and weaknesses in security associated with the transmission of such electronic messages.

### 2) Description of the Related Art

The use of electronic message, especially email, is prevalent in today's society. It is estimated that billions of emails are sent per day. Email is being used for several purposes including personal communications, business communications, marketing, advertising, multi-party communications, collaboration, transmitting attachments, document or any other information interactions, and many other uses. Because of its increased use as well as the increase in security risks with modern communications, a system that can assist with the identification of security risks, analysis of weaknesses and the ability to provide recommendations would be desirable.

Some of the undesirable uses of email addresses by those such as hackers can include phishing attempts, spam, attempted to obtain financial and personal information and other undesirable and even illegal activities. Generally, phishing refers to an attempt to gather private, confidential, or protected information by social engineering which seeks to have potential victims disclose sensitive information under false pretenses. Phishing attacks are usually carried out via communication channels such as email or instant messaging by fraudulent or misleading actors posing as legitimate and trustworthy entities so that the victim “trust” the bad actor and discloses such information. It is desirable to identify risks that can lead to successful phishing attempts and provide preventive measures so that these attempts can be reduced if not eliminated.

There have been attempts to automatically filter or identify undesirable electronic messages such as shown in United State U.S. Pat. No. 9,501,746 which discloses a system related to detecting bad actors impersonate other people's identity in order to increase the likelihood of recipients opening these bad actors' messages and attachments. This patent states that this undesirable activity is generally referred to as “phishing” and specifically “spear phishing” when the recipient is targeted by the fake sender who is referred to as a “phisher”. This patent also states that these phishers send these “fake emails” seeking to increase their likelihood of successfully gaining unauthorized access to confidential data, trade secrets, state secrets, military information, and other information. The motivation of these phishers is typically for financial gain through fraud, identity theft and/or data theft as well as those which wish to disrupt normal operations. Phishing attempts have been associated with private entities as well as being state sponsored and even foreign government themselves.

Once attempt to detect and/or handle targeted attacks is show in U.S. Pat. Nos. 9,686,308 and 10,181,957 disclose a system for detecting and/or handling target attacks in an enterprise's email channel. This patent discloses receiving aspects of an incoming electronic message addressed to a first email account holder, selecting a recipient interaction profile and/or a sender profile from a plurality of predetermined profiles stored in a memory, determining a message trust rating associated with the incoming email message based upon the incoming email message and the selected recipient interaction profile and/or the sender profile; and generating an alert identifying the incoming email message as including a security risk based upon the determined message trust rating. However, these techniques are limited to the message being received by the electronic message system and limited to the relationship between the sender and the recipient. It would be advantageous to have a system that can reduce the risks of such attacks and other security risks so that the email owner's security protection can be increased.

Typically, attempt to reduce email risks include an “after the fact” designed to react to phishing attempts is shown in U.S. Pat. No. 7,634,810. This patent discloses a phishing detection module that detects a phishing attack in the communication by determining if the domain of the message source is similar to a known phishing domain, or by detecting suspicious network properties of the domain. This attempt requires that information about the message domain is known allowing bad actors to simply change domains to overcome this system.

Another attempt to detect, prevent and provide notification of phishing attempts is shown in U.S. Pat. No. 10,404,745 which discloses the use of natural language techniques and information present in an email (namely the header, links, and text in the body) to detect phishing. This system is limited to an analysis of the email itself and occurs once the phishing attempt or attack has been initiated. It would be advantageous to reduce the ability of a phishing attempt to occur in the first place, rather than an “after-the-fact” solution as in the prior art.

One risk with email is that it is a plain text communication which allows other to potentially see the contents. There are some preventative measures that can be taken to tighten security that include the use of transport layer security (TLS). TLS is a form of encryption that protects email while it's in transit. When using TLS, a sender's email service will request the receiving email service to start the secure connection. If a secure connection can be provided, the sending service will share the necessary list of protocols and ciphers needed to encrypt the message content. Then, the email sends securely to the recipient using a public key to encrypt and a private key to decrypt. While TLS is relatively easy to use, it does require administrative tasks and support which can be either not implemented, not properly implemented, or improperly modified when chances to an email server occur. Further, an up-to-date TLS certification is required and needs to be monitored. TLS, while recommended, only protects the email in transmit so that other protections are needed for a comprehensive surety system directed to email communications. Nevertheless, a system that allows for analysis and reporting of TLS properly being installed and used would be advantageous.

Another risk associated with email systems is the mail exchange (MX) record which, based upon its configuration, can expose the sender's origin IP address and therefore increase the risk of a denial-of-service attack. The MX record includes information for sending email services (e.g., servers), such as the name of the responsible server for accepting emails on behalf of the domain and establishes a link between the domain name and the inbound mail service. The MX record is used, generally, in the following process: (A) an email is sent to a email address having a domain name. The sending mail service uses the domain name and inquires there the name services are located; (B) the domain replies with a MX record that informs the sender's mail service what servers are allowed to receive the email to that domain and (C) the sender receives the MX record and based upon the hosts or hosts in the MX record, request the service's IP address. In certain configurations the MX record can be configured to obscure the original IP reducing the security risks associated with the MX record information.

One standard that has developed for email security is the domain keys identified mail (DKIM) standard. This standard assists in the detection of alterations in an email while in transit between a sending service and a receiving service. Generally, DKIM uses a public key to sign email with a sender's private key as it leaves a sending service. The recipient service then uses a public key published to the DKIM's domain to verify the source of the message and that the contents of the message included in the DKIM signature haven't changed since the message was signed. If the email message signature is verified with the public key by the recipient service, the message is considered authentic. DKIM makes spoofing harder from the senders' email domain. Further, the DKIM standard is used by internet service provides (ISP) to build a reputation for a domain over time thereby improving email deliverability as more trust is built. It is also important to note that DKIM is not an encryption protocol and therefore is best used in combination with TLS or similar technologies.

Another mechanism that can be used for improved email protection is sender policy framework (SPF). SPF is a type of DNS TXT record that lists all the servers authorized to send emails from a particular domain. Generally, SPF works by sending an email from a first server with an IP address and a return path email address. The receiving server uses the return path email address and searches for the SPF record. A second server finds the SPF record for the return path email address (domain) and determines if the first server is an authorized sender. If the IP address listed in the SPF record than the email will be delivered. If the IP address is not in the SPF record, then the email can be rejected, marked as spam or otherwise disposed. SPF records are used to reduce the risks of risk for phishing attacks, spam emails, and email spoofing by making it harder to imitate a domain. SPF can be used with DMARC validation so that domain-based message authentication reporting and conformance (DMARC) policies can be used to determine what happens to a rejected email.

DMARC is a method of authenticating email messages and informs receiving email services what actions to take under a SPG and DKIM. DMARC reduces or prevents email spoofing. DMARC can reduce the risk of and prevent malicious parties, hackers, and spammers from sending emails from a domain that they are not authorized to use.

Another system that can be used to reduce surety risks with emails is by retrieving and analyzing the IP reputation to assist with detecting bots, blocking email SPAM, preventing fake registrations, and verifying users. In some designs, the IP reputation is based on the properties of the sender's IP address, such as if it's located in a data center, originating from a hosting provider, or from a residential or wireless network. The IP address, based upon activity from the IP address, can be associated with a probability of malicious intent. Factors that can affect an IP reputation include the use of VPNs, proxies or other anonymous IP address schemes as malicious user wish to mask their identity. Stated generally, the IP reputation is an estimated behavior quality exhibited by an IP address where IP addresses frequently used by bots, scammers, hackers, spammers, cybercriminals, or other malicious users have much lower IP reputation than an address used for legitimate browsing behavior online. Internal systems and third-party services can provide IP reputational scores.

Another risk that can be associated with email communications is the ability to preform a reverse DNS lookup. Reverse DNS lookup is associated with marketing strategies as well as used to prevent malicious users such as spammers and phishing attempts. Properly used, reverse DNS lookup can validate the IP address of an incoming email against the data stored at that domain and if the email is sent from a potentially compromised service, server or deliberate spammer, the reverse DNS results may show an address that does not exist. In this case, the email can be flagged as problematic. A pointer record (PTR) is a type of DNS record that stores the domain of an IP address and maps the IP address to a hostname. Therefore, having a PTR record is beneficial so that email systems can check whether the IP address of a sending service has a matching forward and reverse DNS record.

As shown above, email protections strategies are not as simple as subscribing to a spam filter and require a layered approach, which reduces risks. Generally, the more layers, the greater the reduction in risk. Layers include the systems, techniques, frameworks, and other methods discussed above. Further, changes in the email system can result in one or more of the installed schemes being changes, outdated, improperly configured or otherwise less than optimal. Understanding what is installed, configured, and properly operating would be beneficial for the reduction in the risks associated with email communications.

Therefore, it is an object of the system to provide for a system that can identify email security risks and weakness.

It is another object of the system to provide a security score to represent the risks associated with an email system.

It is another object of the system to provide potential mitigation suggestions.

### BRIEF SUMMARY OF THE INVENTION

The above objectives are accomplished by providing a system for analyzing an electronic communication system. The system comprises a set of computer readable instructions stored in a tangible medium. The system includes a data source module included in the computer readable instructions and in communication with an electronic message system and configured to receive data from a plurality of distinct data sources. The plurality of distinct data sources is taken from the group of: static email configuration data associated with an email domain, live organizational data providing real-time visibility into email traffic associated with an organization, external DMARC forensic data including authentication results and spoofing attempt information from sources external to the organization, and aggregate reports including third-party reports and telemetry data.

The data source module can collect and aggregate information from the plurality of distinct data sources, and the analysis engine can fuse this data by correlating configuration states with observed traffic patterns and external authentication results. In some aspects, the fusion process may involve comparing static email configuration data against live organizational data to identify discrepancies between intended security policies and actual email behavior. The analysis engine may also correlate external DMARC forensic data with internal configuration settings to determine whether authentication failures reported by external mail servers correspond to configuration issues within the organization's email infrastructure. In some cases, the aggregate reports and telemetry data can be combined with the other data sources to provide historical context and trend information that informs the unified analysis.

The system includes an analysis engine in communication with the data source module and configured to receive the data from the plurality of distinct data sources, fuse the data from the plurality of distinct data sources into a unified analysis, generate a dynamic security score based on the unified analysis, and provide continuous compliance validation for the email domain.

The dynamic security score can be generated by the analysis engine based on the continuous evaluation of multiple factors derived from the plurality of distinct data sources. In some aspects, the security score may be calculated by assigning weighted values to different security dimensions, including configuration compliance, authentication success rates, threat activity levels, and historical trend data. The analysis engine can adjust the security score in response to changes detected in any of the data sources, such as when a configuration drift is identified in the static email configuration data or when new spoofing attempts are reported in the external DMARC forensic data.

In some cases, the dynamic security score may increase when the analysis engine detects improvements in the email security posture, such as the successful implementation of previously missing authentication mechanisms or the resolution of configuration issues. Conversely, the security score may decrease when the analysis engine identifies new vulnerabilities, misconfigurations, or elevated threat activity. The analysis engine can track the security score over time to identify trends and patterns that may indicate gradual degradation or improvement in the organization's email security posture.

The dynamic nature of the security score can reflect the real-time state of the email environment by incorporating live organizational data that provides visibility into current email traffic patterns and authentication outcomes. In some embodiments, the analysis engine may recalculate the security score at regular intervals or in response to specific events, such as the detection of a configuration change or the receipt of new DMARC reports from external sources. The security score can be presented as a numerical value, a letter grade, or other representation that conveys the overall security posture of the email domain to administrators or managed service providers.

Telemetry data can include information automatically collected and transmitted from remote sources regarding the performance, status, and behavior of email systems and related infrastructure. In some aspects, telemetry data may encompass metrics such as message delivery rates, authentication pass and fail counts, latency measurements, error logs, and other operational data that can be used to assess the health and security posture of an email environment over time.

In some aspects, the external DMARC forensic data can be provided to the system through DMARC reporting mechanisms that receiving mail servers generate when processing messages purporting to originate from the organization's domain. When an organization publishes a DMARC record in its DNS configuration, the record can include reporting addresses where external email service providers send authentication results. These reports can be transmitted to the system in two forms: aggregate reports that provide statistical summaries of authentication outcomes over a period of time, and forensic reports that contain detailed information about individual messages that failed authentication checks. The external sources providing this data can include major email service providers such as Google, Microsoft, Yahoo, and other organizations that receive email traffic claiming to originate from the monitored domain. In some cases, the system can receive DMARC data through integration with third-party DMARC processing services that collect, parse, and normalize reports from multiple external sources. The external DMARC forensic data can include information such as the IP addresses of servers that attempted to send messages using the organization's domain, the authentication results for SPF and DKIM checks performed by receiving servers, and details about messages that may represent spoofing attempts. In some embodiments, the system can process DMARC reports received via email to designated reporting addresses or through API connections with DMARC aggregation services that consolidate reporting data from across the internet.

In one example, providing real-time visibility into email traffic can mean continuously monitoring the flow of messages across an organization's email infrastructure to detect patterns, anomalies, and potential threats as they occur. Instead of relying on periodic reports or delayed logs, real-time monitoring tools capture live data streams, e.g., sender and recipient information, authentication results (SPF, DKIM, DMARC), message volume, attachment types, and delivery outcomes, and present them to the system, in dashboards or as alerts. This visibility allowsthe system to quickly identify unusual spikes in traffic, unauthorized sending sources, or suspicious content that could indicate phishing or malware campaigns. It also supports compliance by ensuring that outbound messages adhere to policy and that inbound traffic is properly filtered. By maintaining this continuous oversight, organizations can respond immediately to issues, safeguard domain reputation, and ensure that legitimate communications reach their intended recipients without interruption.

Continuous compliance validation for the email domain can include ongoing checks that verify the email system maintains adherence to security policies and authentication standards over time. In some aspects, the analysis engine can perform regular audits of configuration settings to confirm that SPF, DKIM, DMARC, and TLS configurations remain properly implemented and have not degraded or been inadvertently modified. The continuous compliance validation can include monitoring for changes to DNS records that may affect email authentication, tracking certificate expiration dates, and verifying that authorized sending servers remain consistent with published policies. In some cases, the system can compare current configuration states against baseline configurations or industry standards to identify deviations that may indicate compliance issues. The ongoing monitoring can detect when third-party services integrated with the email system are updated or reconfigured in ways that affect authentication mechanisms. In some embodiments, the continuous compliance validation can generate periodic compliance reports that document the email domain's adherence to security requirements and can provide alerts when compliance status changes. The regular audits can include verification that DMARC policies are being enforced as intended by receiving mail servers and that authentication pass rates remain within acceptable thresholds.

The analysis engine calculates a security score and generates human-readable reports that summarize a historical configuration trend, a threat activity, and the security score.

According to other aspects of the present disclosure, the system may include one or more of the following features. The static email configuration data may include at least one of SPF configuration settings, DKIM configuration settings, or TLS configuration settings. The analysis engine may be further configured to perform proactive configuration drift monitoring by running periodic tests of the static email configuration data and detecting misconfigurations and regressions. The analysis engine may be further configured to generate an alert when configuration drift is detected. The analysis engine may be further configured to categorize alerts by a severity and a source, the source including at least one of internal misconfigurations, traffic anomalies, or external spoofing attempts. The analysis engine may include a modular DMARC processing layer configured to ingest, analyze, and enforce DMARC policy and telemetry data from the external DMARC forensic data. The system may be configured to support multi-tenant administration, allowing management of a plurality of organizations from a single platform, and the analysis engine may be configured to provide organization-specific visibility and alerts while normalizing email security posture across client domains. The analysis engine may be further configured to correlate a configuration change detected in the static email configuration data with authentication failures reported in the external DMARC forensic data to identify a root cause of email delivery issues. The system may further comprise automated deployment capabilities configured to automatically generate and deploy DNS records for at least one of SPF, DKIM, or DMARC associated with the email domain.

According to another aspect of the present disclosure, a system for monitoring email security configurations is provided. The system comprises a processor and a memory coupled to the processor and storing computer readable instructions. The computer readable instructions, when executed by the processor, cause the system to receive static email configuration data associated with an email domain, the static email configuration data including configuration settings for at least one of SPF, DKIM, or TLS. The computer readable instructions cause the system to receive live organizational data providing visibility into email traffic associated with an organization. The computer readable instructions cause the system to receive external DMARC data including authentication results from sources external to the organization. The computer readable instructions cause the system to aggregate the static email configuration data, the live organizational data, and the external DMARC data. The computer readable instructions cause the system to analyze the aggregated data to detect at least one of misconfigurations, configuration drift, or security threats. The computer readable instructions cause the system to generate a security score based on the analysis of the aggregated data.

According to other aspects of the present disclosure, the system may include one or more of the following features. The computer readable instructions may further cause the system to perform proactive configuration drift monitoring by automatically running periodic tests of the static email configuration data and detecting regressions over time. The computer readable instructions may further cause the system to generate an alert when configuration drift is detected, the alert being categorized by a severity and a source. The source may include at least one of internal misconfigurations, traffic anomalies, or external spoofing attempts. The computer readable instructions may further cause the system to generate a human-readable report summarizing at least one of historical configuration trends, threat activity, or the security score. The computer readable instructions may further cause the system to correlate a configuration change detected in the static email configuration data with authentication failures reported in the external DMARC data to identify a root cause of an email delivery issue.

According to another aspect of the present disclosure, a system for multi-source email security analysis is provided. The system comprises a data aggregation module configured to collect static email configuration data associated with an email domain, collect live mail flow data from an organization's email traffic, and collect aggregate reports from external sources. The system comprises an analysis engine in communications with a mail security platform configured to receive the static email configuration data, the live mail flow data, and aggregate reports from the data aggregation module. The analysis engine is configured to correlate data across the static email configuration data, the live mail flow data, and aggregate reports to identify security issues. The analysis engine is configured to generate alerts categorized by a severity and a source based on the correlated data.

The analysis engine can be in communication with the mail security platform through various integration mechanisms. In some aspects, the analysis engine may establish communication with the mail security platform through application programming interfaces (APIs) that allow for the exchange of data and commands between the two systems. The API connections can enable the analysis engine to query the mail security platform for live mail flow data, retrieve authentication results, and receive notifications when security-relevant events occur.

In some embodiments, the communication between the analysis engine and the mail security platform can be implemented through webhook configurations where the mail security platform pushes data to the analysis engine when specific events are detected, such as authentication failures or unusual traffic patterns. The webhook approach can reduce latency in data transmission and enable near real-time analysis of email security events.

The analysis engine may also communicate with the mail security platform through message queues or event streaming systems that buffer and transmit data between the components. In some cases, this approach can provide reliability and scalability when processing large volumes of email traffic data.

In some aspects, the analysis engine can be deployed as an extension or module within the mail security platform itself, enabling direct access to internal data structures and processing pipelines. This integrated deployment can reduce network overhead and simplify data access patterns.

The communication between the analysis engine and the mail security platform may also occur through shared database connections where both systems read from and write to common data stores. In some embodiments, the mail security platform can populate database tables with email traffic information that the analysis engine subsequently queries for analysis purposes.

In some cases, the analysis engine can communicate with the mail security platform through secure network protocols such as TLS-encrypted connections to protect the confidentiality and integrity of data transmitted between the systems.

According to other aspects of the present disclosure, the system may include one or more of the following features. The analysis engine may be further configured to perform proactive configuration drift monitoring by automatically running periodic tests of the static email configuration data and detecting regressions over time. The analysis engine may be further configured to generate a notification when configuration drift is detected, allowing for intervention before service degradation or security breaches occur. The analysis engine may be further configured to generate human-readable reports summarizing historical configuration trends, threat activity, and current security scores for delivery to clients. The system may be configured to support multi-tenant administration, allowing management of a plurality of organizations from a single platform, and the analysis engine may be configured to normalize email security posture across client domains for consistent monitoring and reporting.

The data source module can receive data from multiple distinct data sources that are fused into a unified analysis by the analysis engine. The static email configuration data can include configuration settings such as SPF, DKIM, and TLS that define the authentication and encryption parameters for an email domain. The live organizational data can provide real-time visibility into email traffic patterns, enabling detection of anomalies and threats as they occur. The external DMARC forensic data can include authentication results and spoofing attempt information gathered from external email service providers that receive messages purporting to originate from the organization's domain.

The analysis engine can perform proactive configuration drift monitoring by running periodic tests, such as nightly tests, of the static email configuration data. Configuration drift can occur when security settings change over time from a known or desired state, potentially resulting from administrative changes, DNS record updates, certificate expirations, or modifications during system maintenance. The analysis engine can detect misconfigurations and regressions over time and generate alerts when such drift is detected. Early detection and correction of configuration drift, including SPF and DKIM configuration drift, can prevent legitimate outbound emails from being rejected or marked as spam by receiving mail servers.

The analysis engine can categorize alerts by severity and source, distinguishing between internal misconfigurations, traffic anomalies, and external spoofing attempts. The analysis engine can include a modular DMARC processing layer that can ingest, analyze, and enforce DMARC policy and telemetry data. The modular architecture can be designed to work with external providers or internally managed systems, allowing for backend replacement or in-house implementation without changing the application layer.

The system can support multi-tenant administration, allowing a managed service provider to manage multiple organizations from a single platform. The analysis engine can provide organization-specific visibility and alerts while normalizing email security posture across client domains for consistent monitoring and reporting. The analysis engine can correlate configuration changes detected in the static email configuration data with authentication failures reported in the external DMARC data to identify root causes of email delivery issues.

The system can include automated deployment capabilities configured to automatically generate and deploy DNS records for SPF, DKIM, or DMARC associated with the email domain. The automated deployment can reduce the likelihood of human error during initial configuration and can enable zero-touch configuration where possible. The data aggregation module can collect static email configuration data, live mail flow data, and aggregate reports from external sources, and the analysis engine can correlate data across these sources to identify security issues and generate alerts based on the correlated data.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of aspects of the system.

FIG. 2 is a schematic of aspects of the system.

FIG. 3 is a flowchart of aspects of the system.

FIG. 4 is a flowchart of aspects of the system.

FIG. 5 is a flowchart of aspects of the system.

FIG. 6 is a flowchart of aspects of the system.

FIG. 7 is a flowchart of aspects of the system.

FIG. 8 is a flowchart of aspects of the system.

FIG. 9 is a flowchart of aspects of the system.

FIG. 10 is a schematic of aspects of the system.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

With reference to the drawings, the invention will now be described in more detail.

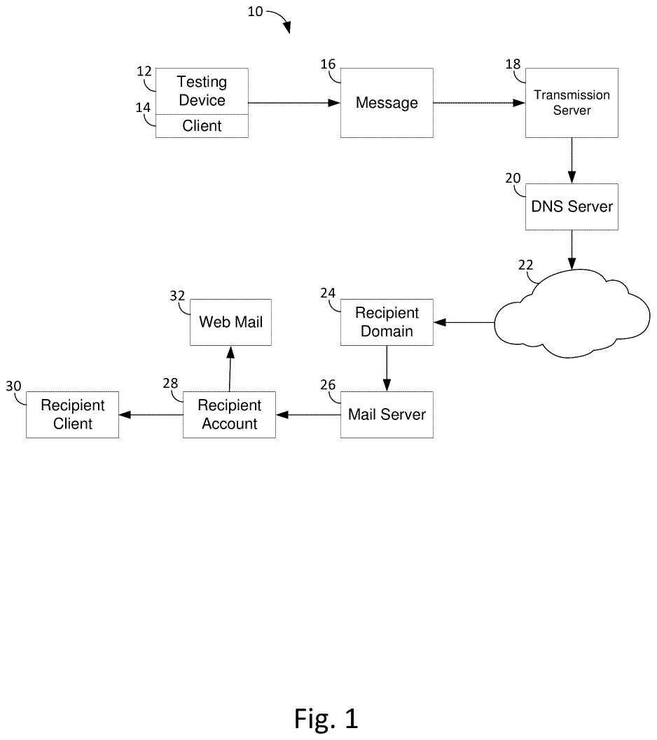

Referring to FIG. 1, and using an email system as an example, a testing system shown generally as 10. The testing computer device 12 can be accessed directly or through SaaS (e.g., cloud based). In one embodiment, the testing system can receive an email to be testing through the SaaS configuration wherein a user enters the email on the SaaS platform. The testing system, using an email client 14 or testing device 12 can then transmit a test email 16 to a transmission server 18. The testing system composes the test email that is transmitted through a transmission server, such as an SMTP server, and then directed by a domain name system (DNS) 20. The domain name system can provide information where to send the electronic message through a global communications network 22. The electronic message is then transmitted to a domain 24 of the recipient, on to a mail server 26 and then to the recipient account 28 and recipient client 30. The test email contains the email of the recipient as that is the email to be tested. The recipient is requested to reply to the test email thereby creating and transmitted a test reply. The test reply is transmitted back to the testing system 10. In some embodiments, the recipient can access the user account receiving the test email through a browser such as webmail 32.

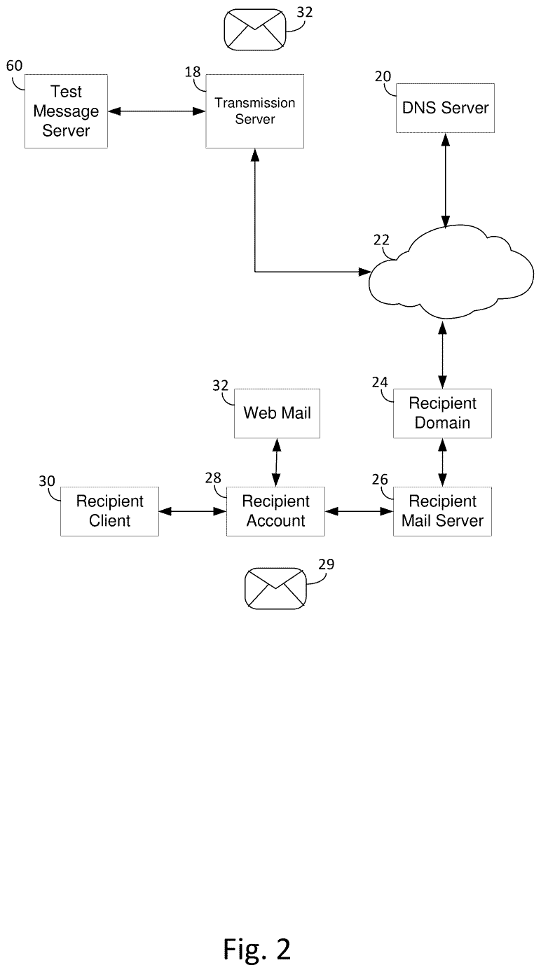

Referring to FIG. 2, the testing system can create test email 32 that can be transmitted to the recipient's email. The test email includes the email address of the email to be tested. The test email is transmitted to the recipient's domain 24 designated for delivery to the recipient's account 28 (e.g., the recipient's email system). The recipient is then provided instructions to respond to the test email and create a test reply 29. For example, the user (e.g., recipient) can be instructed to “Simply tap ‘reply’ and then; send; so we can test your outbound email security and generate your full report” which such instructions can be contained in the content of the test email 32. When the user replies, a test reply 29 can be addressed to an email account associated with the testing system. The reply email can be addressed to a unique email associated with the user's request for testing.

During the process of creating the test email, transmitting the test email and receiving the test reply, the testing system can analyze components of the communications and provide information concerning the security of the email. For example, the testing system can retrieve and inspect the email header seeking information about TLS. By way of illustration, an email header can include the following:

| | |
|---|---|
| Received: from CY4PR2201MB1384.namprd22.prod.outlook.com | |
| (2603:10b6:910:6a::22) by SN4PR22MB2902.namprd22.prod.outlook.com | (1) |
| with HTTPS; Tue, 28 Jun 2022 14:55:33 +0000 | |
| Received: from MW2NAM04FT012.eop-NAM04.prod.protection.outlook.com | |
| (2603:10b6:303:2a:cafe::2) by MW3PR06CA0018.outlook.office365.com | (2) |
| (2603:10b6:303:2a::23) with Microsoft SMTP Server (version=TLS1_2, | |
| cipher=TLS_ECDHE_RSA_WITH_AES_256_GCM_SHA384) id | |
| 15.20.5373.16 via Frontend Transport; Tue, 28 Jun 2022 14:55:31 +0000> | |
| Received: from otransport-12.outbound.emailsrv.net (52.1.62.31) by | |
| MW2NAM04FT012.mail.protection.outlook.com (10.13.31.127) with | (3) |
| Microsoft SMTP Server (version=TLS1_2, | |
| cipher=TLS_ECDHE_RSA_WITH_AES_256_GCM_SHA384) id | |
| 15.20.5373.15 via Frontend Transport; Tue, 28 Jun 2022 14:55:31 +0000 | |
| Received: from NAM10-MW2-obe.outbound.protection.outlook.com (mail- | |
| mw2nam10Ip2106.outbound.protection.outlook.com [104.47.55.106]) by | (4) |
| ogate-3.outbound.emailservice.io (Postfix) with ESMTPS id D2D80A966C | |
| for ; Tue, 28 Jun 2022 14:55:29 +0000 (UTC) | |
| DKIM-Signature: v=1; a=rsa-sha256; c=relaxed/relaxed; | |
| d=Mailprotector.onmicrosoft.com; s=selector2-Mailprotector-onmicrosoft- | |
| com; | (7) |
| h=From:Date:Subject:Message-ID:Content-Type:MIME-Version:X-MS- | |
| Exchange-SenderADCheck; | |
| bh=CN+f5XFwIaGaTKhNrulNut5x7oE5mnx3t4xVl+4qvkQ=; | |
| Received: from DM4PR19MB5761.namprd19.prod.outlook.com | |
| (2603:10b6:8:60::17) by BN0PR19MB5278.namprd19.prod.outlook.com | |
| (2603:10b6:408:151::17) with Microsoft SMTP Server (version=TLS1_2, | (8) |
| cipher=TLS_ECDHE_RSA_WITH_AES_256_GCM_SHA384) id | |
| 15.20.5373.18; Tue, 28 Jun 2022 14:55:26 +0000 | |
| Received: from DM4PR19MB5761.namprd19.prod.outlook.com | |
| ([fe80::d447:8c8:3b5c:1119]) by | (9) |
| DM4PR19MB5761.namprd19.prod.outlook.com | |
| ([fe80::d447:8c8:3b5c:1119%9]) with mapi id 15.20.5373.018; Tue, 28 Jun | |
| 2022 14:55:26 +0000 | |
| From: Ben Hathaway | |
| To: Douglas Kim | |
| CC: David Setzer | |
| Subject: Re: Radar Patent and Trademark(s) | |
| Thread-Topic: Radar Patent and Trademark(s) | (10) |
| Thread-Index: | |
| AQHYiiN1/xl9gZsj6EuDAE8S5xw5nq1k0sUAgAAKU4CAAAbpglAABesA | |
| Date: Tue, 28 Jun 2022 14:55:26 +0000 | |
| Message-ID: <4397EC37-3901-4122-AE57- | |
| 28305CF8B2F7@mailprotector.com> | |
| In-Reply-To: | |
| Accept-Language: en-US | |
| Content-Language: en-US | |
| X-MS-Has-Attach: | |
| X-MS-TNEF-Correlator: | (11) |
| Authentication-Results-Original: | |
| dkim=none (message not signed) | |
| header.d=none; | |
| dmarc=none action=none | |
| header.from=mailprotector.com; | |
| spf=none; | |
| X-Microsoft-Antispam-Message-Info-Original: | |
| zzKZNSEnd7Z8oihwEWwkiQF6Pvi6TIllobQXfo7PWxoDRY9M29iCAY3YrP9 | |
| cnFYiGy0Uf0DB7HPRnb0pAMo8kEIVS7yw1YNCJY9KfDuMkpcD5u8Tz/gvv | |
| N+fXS/liXZZFGMQQ9w/GCm4PZBsEQJ7vF2h7wWaMVWdK9BzkW5uJMx | |
| BqFyRsKeHMDOJmq+HdCAfUcQH0qJegXbkoXBFiVqlCIL787luOh6LGcx3 | |
| N28FaW/WycZlpTKTq54CQjUU99JaMPpdVWfxh7Qz4Zv35CQ3PqwgODU | |
| GasTYdM9BYxULY1aPyYBtvTKyrkJqOrX/6EIEAndqS5MvDKDP5xBT26zI3 | |
| vy+E+s87XLW5/VZNUilgclqLKQAOYuDYPugHVZG4ENwy97it1eEb4Jblz4e | (12) |
| u0HXtCRtl9uv40mr3/m/YV8iexZtnP21bNUG85n82JVrbBwz7W6kS/g3FVzO | |
| SlrFncs1ARF8trPLOiLxIBUQ4NNzSWohQhwRg8cm2fPOrziSv58l/TtA3NWd | |
| J+trW8BDJjfuHDzWY/bL4vmZhU9h7uNw7fAsmW+sdtniEyaKeenYPrOdwB | |
| ShIbfqQ42vHNag+EH/xLjUCBDcZjUICeLelitPBHffoDtcaGtIVBE2zqkXWvYB | |
| J5tXUrpZ3vG7PdE8ejtv41yNku1Oc2NrvZIFt2J2/w5Ubt80msrQ4VB1X1IPrY | |
| FAGjZW8incjFwCXEMjg4oC5+UioHpWhk+dq9/v0BMgSZhdmknhcVAGW4f | |
| xLkd2/ufjMYsc07/P+B9qrmT6fuNIv2mkL4KROvs0IQwAoq38dyvbmreofMFb | |
| rwVizdWArpDGaNnrxqlpllhcLSzpOxA4Qiin/AT/rwjFGI+y1t9XIMe68iAAqORj | |
| rw9zbMG03+PBWJ9fFwZdNpZeWeeB+73uHdRA8hm1uhiezKsM4PVOUsU | |
| = | |

From an analysis of the information for this email header, it can be seen that this test email went through several servers, each with certain information. Reviewing each of the “Received” header information, we can see that TLS encryption was used by each server. Therefore, the testing system can determine if TLS is used among the test email path and increase a security score when TLS is present at each stage and reduce a security score when TLS is missing from one or more servers in the transmission path from the testing system to the recipient and back.

The system can also use the test message and the reply message to attempt establish a TLS connection. In establishing these connections, the testing system can analyze the connection, determine if it is a secure connection and can review the certificate for validity and expiration. If the TLS certificate is missing or expired, the system can provide a notification and can lower the score. This analysis can also apply to message system access using https and determine if the certificate associated with the https is present and valid.

Further, each “Received” header includes a date and time timestamp so that the delay created by the transmission services (e.g., servers) can be calculated. The delay can be used to determine the performance of the message system. In one embodiment, performance information can be provided to the user inquiring about the message domain. The testing system can also determine if the “From address” has been blacklisted and increase security score in the event that one or more of the domains in the travel path of the email are blacklisted. From the header information, the testing system can determine if the DKIM record is aligned or not aligned. In this process, the testing system can determine if the message are properly cryptographically signed and therefore can provide for authentication of a message. When the DKIM record is missing, the score can be lowered.

The testing system can also review the MX record associated with the email address to be tested and determine if the MC record exposes the email hosting system. In some configurations, especially those that are less secure, the MX record points to the email service or service used by the email address being tested. This exposes the email server increasing the risks that someone with malicious intent sends an email message that appears to originate from a seemingly trusted email domain, as the malicious user gains information about the email domain from the MX record. In the event that the MX record exposes directly the email domain, the security score can be lower.

The testing system can review the SPF record and determine if the SPF record is present and properly configured. In the example above, there is no SPF record and therefore the security score can be lowered. The SPF record can also be reviewed to determine if there are third party domain that can send emails on behalf of the organization associated with the email being tested.

The testing system can review the DMARC DNS record and determine if the DMARC record is present and properly configured. In the example above, there is no DMARC record and therefore the security score can be lowered. The missing DMARC record prevents the ability to see threats targeting the organization associated with the email being tested.

The testing system can review the IP associated with the test email and reply email and retrieve an IP reputation from an internal source associated with the testing system or from a third-party provider. A negative reputation can result in a lower security score.

The testing system can also preform a reverse DNS lookup using the IP address associated with the test email. The IP address is used to determine the hostname associated with the test email. If there is no pointer record (PTR) then reverse DNS lookup cannot provide the hostname and the security score may be lower.

The testing system can also use tracking in the test email to determine characteristics associated with the test email and the reply email, for example, if an email has been opened, when, the location and the type of device that was used to read the email. The test email can include a tracking pixel or other tracking item that can be included in the email. The testing email, when opened, can inform the testing system that the tracking item was allowed and therefore the security score lowered. The test email system inability to filter or stop tracking pixels increases the security risks associated with the test email.

In one embodiment, the security score begins with a initial security score and then when each analyzed item is not represent or fails to provide proper security, deduction are made to the security score. For example, Table 1 illustrates potential deductions:

TABLE 1

| Analyzed Item | Deduction (points) |
|---|---|
| Received Email With (TLS) Encryption | No −150 |
| Transmits Email With (TLS) Encryption | No −150 |
| MX Record Exposes Email Host | Yes −100 |
| DomainKeys Identified Mail (DKIM) used | No −100 |
| Sender Policy Framework used | No −100 |
| Domain/IP Reputation | Negative −100 |
| Domain-based Message Authentication | No −75 |
| Reporting and Conformance (DMARC) used | |
| Reverse DNS IP matches hostname | No −50 |
| Spyware allowed | Yes −25 |

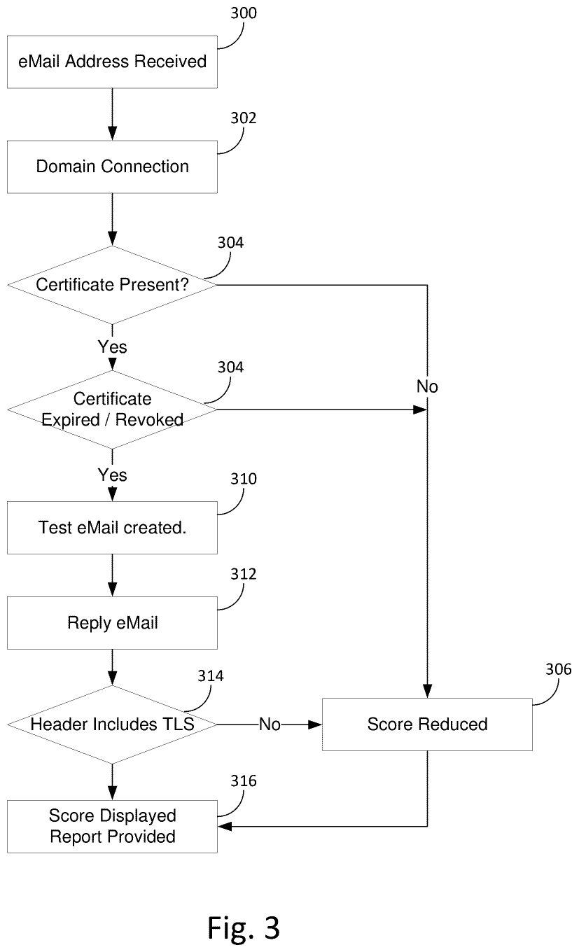

Referring to FIG. 3, the computer readable instructions for illustrating the analysis for TLS encryption for the test email is shown. An email is entered to be tested at 300. A connection to the email domain is attempted at 302. The presence of the TLS certificate can be made at 304 and if the TLS certificate is not present, the score can be reduced at 306. The validity of the certificate can be determined at 308 which can include verification of the digital signature associated with the domain, analysis of the certification chain, including intermediate certificates, review of the expiration or activation dates of the TLS certificate, the revocation status of the certificate and any combination thereof. If the certificate is invalid, the score can be lowered at 306. A test email can be created using the address provided at 310. The test email can be sent to the address provided and a reply email can be returned to the testing system at 312. The test email and the reply email can be analyzed for the TLS information at 314 and if the header information does not include TLS information, the score can be lowered at 306. The score can be provided, or a report can be provided at 316.

The header information can also be used to determent the time that the message is generated, sent, received as well as when a reply is generated, sent and received. The time between these events can be used to determine or analyze the performance of the message system with the longer the time between these events, the less efficient the messages system.

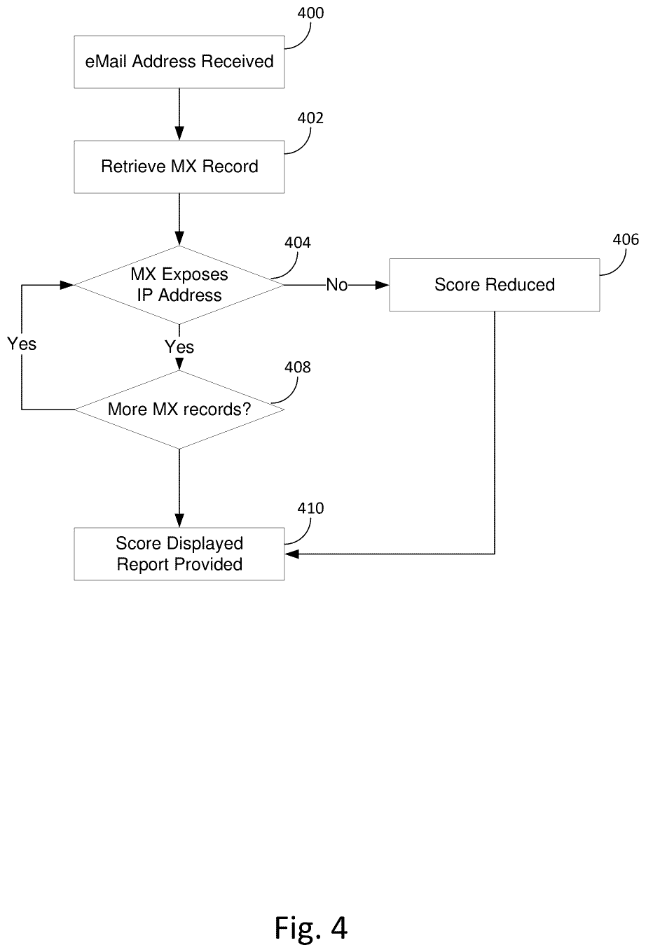

Referring to FIG. 4, the computer readable instructions for illustrating the information revealed by the MX record is shown. An email is entered to be tested at 400. The domain name is used to retrieve the MX record(s) associated with the domain name at 402. A determination is made if the MX record which, based upon its configuration, exposes the sender's origin IP address at 404 and if so, the score can be lowered at 406. A determination is made if there is another MX record, and that MX record can be analyzed at 404. The score can be displayed, or a report generated at 410.

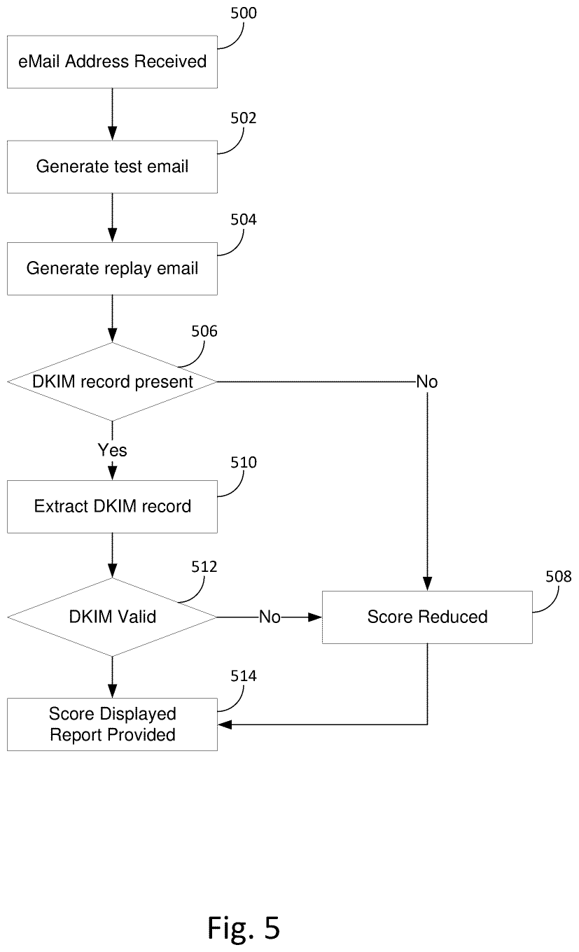

Referring to FIG. 5, the computer readable instructions for illustrating the information revealed by the DKIM record is shown. An email is entered to be tested at 500. A test email addressed to the email provided is generated at 502. The email is sent, and a reply email is requested. The email system to be testing (e.g., the message system that manages the domain in the test email), generates a reply email at 504. The testing system receives the reply email and determines if there is a DKIM signature from the email header and if not, the score can be lowered at 506. If present, the DKIM record can be extracted from the header at 410 and validated using a public key at 512. If the DKIM signature is not valid, the score can be lowered. The score can be displayed, or a report generated at 514.

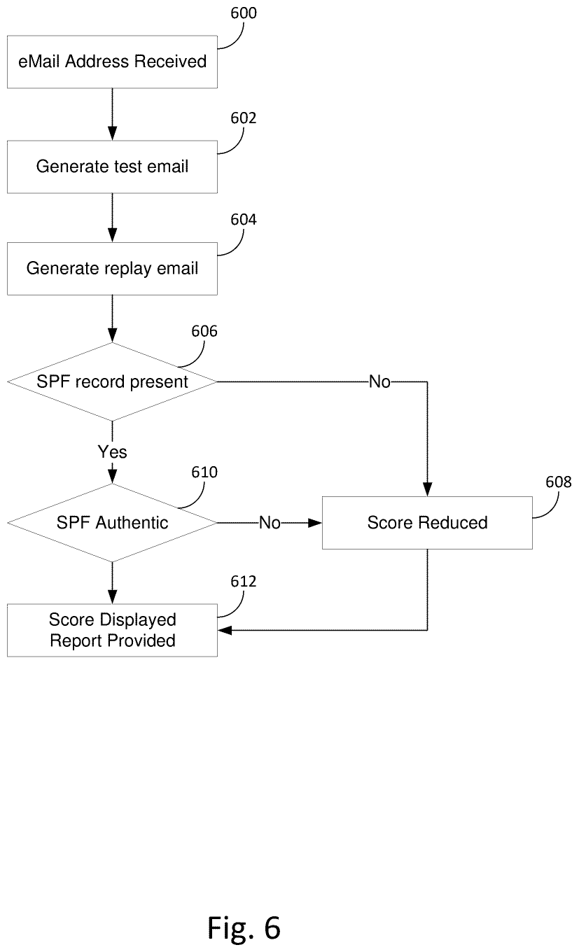

Referring to FIG. 6, the computer readable instructions for illustrating the information revealed by the SPF record is shown. An email is entered to be tested at 600. A test email addressed to the email provided is generated at 602. The email is sent, and a reply email is requested. The email system to be testing (e.g., the message system that manages the domain in the test email), generates a reply email at 604. The testing system receives the reply email and determines if there is a SPF record that can be subject to look up at 606 from the email header and if not, the score can be lowered at 608. If present, the SPF record can be authenticated at 610. If the SPF record is not authenticated (e.g., invalid address), the score can be lowered. The score can be displayed, or a report generated at 612.

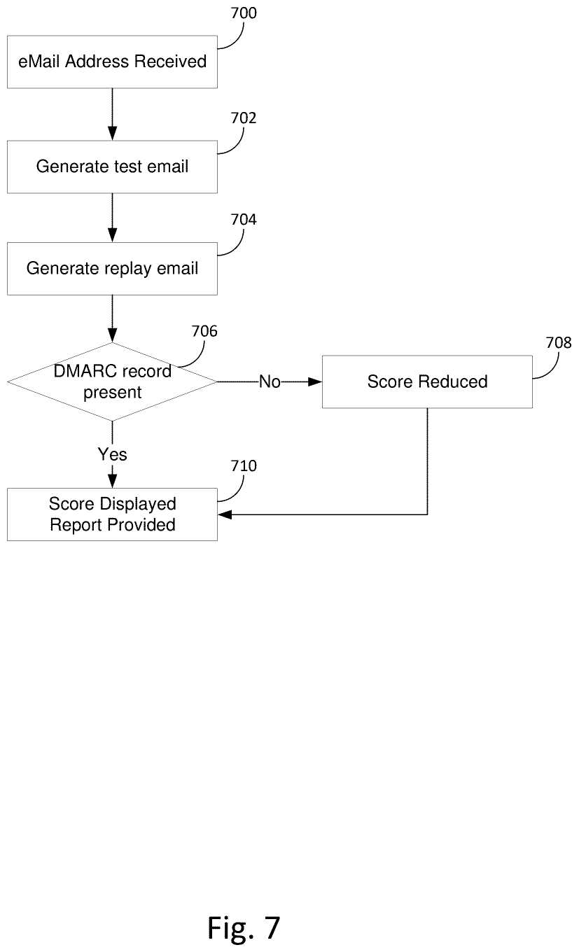

Referring to FIG. 7, the computer readable instructions for illustrating the information revealed by the DMARC record is shown. An email is entered to be tested at 700. A test email addressed to the email provided is generated at 702. The email is sent, and a reply email is requested and generated at 704 which can be received by the testing system. The testing system determine if there is a DMARC record associated with the domain at 706 (e.g., DNS server for the domain) and if not, the score can be lowered at 708. The score can be displayed, or a report generated at 710.

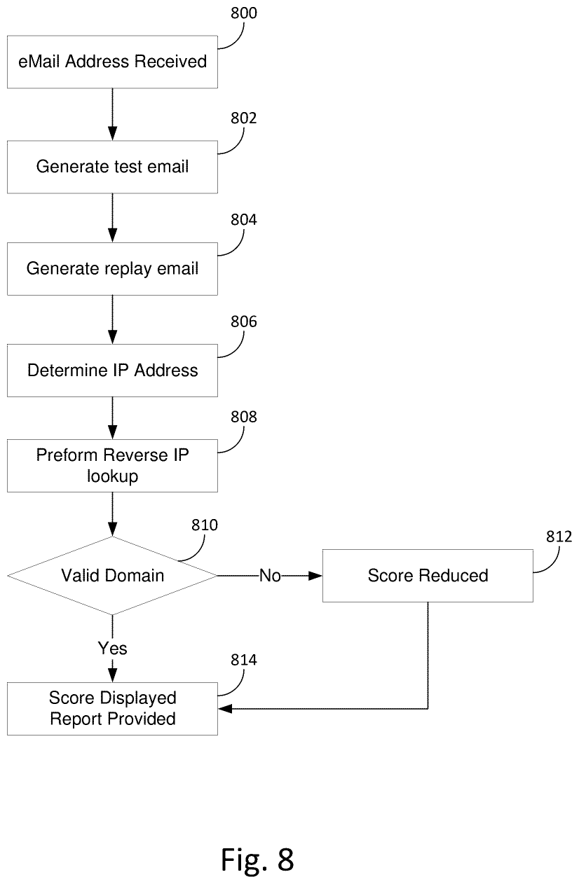

Referring to FIG. 8, the computer readable instructions for illustrating the information revealed by the reverse DNS lookup is shown. An email is entered to be tested at 800. A test email addressed to the email provided is generated at 802. The email is sent, and a reply email is requested and generated at 804 which can be received by the testing system. The IP address associated with the test email domain of the reply email, such as in the reply email header or domain, can be determined at 806. The IP address can then be associated with a domain at 808. If the domain is not a valid domain at 810 the score can be lowered at 812. The score can be displayed, or a report generated at 814. The score can also be lowered when the pointer record of the message system to be tested has a matching forward and reverse DNS record.

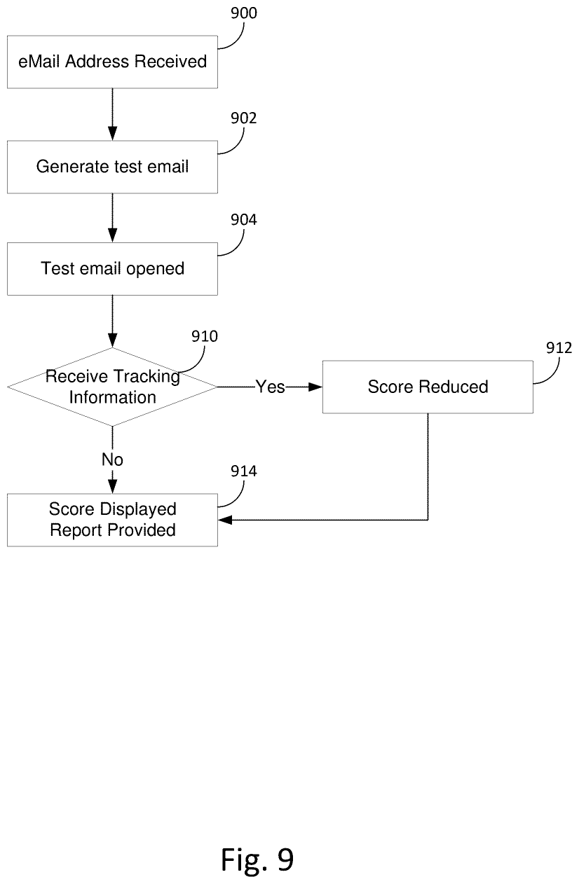

Referring to FIG. 9, the computer readable instructions for illustrating the information revealed by the email tracking information is shown. An email is entered to be tested at 900. A test email addressed to the email provided is generated at 902 and can include a tracker, such as a tracking pixel. The tracking pixel or image can be added to the test email that is sent to the message system to be tested. The target message system can open the test email at 904 and the tracking pixel can load and send a request to an automated email system at 910 that can allow the activity of the test email to be seen, such as opening the test message. If the testing system receives information form the tracking pixel, the target message system score can be lowered at 912. The score can be displayed, or a report generated at 914.

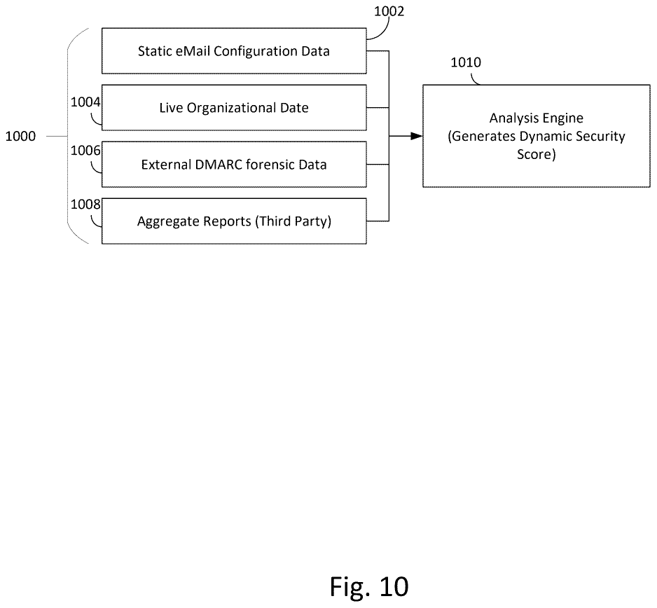

Referring to FIG. 10, a data aggregation and analysis aspects of the system is shown. The system can include a data source module 1000 that provides multiple inputs to an analysis engine 1010. In one embodiment, the data source module 1000 can include multiple distinct data sources, four in this embodiment, that can feed into the analysis engine 1010. In one embodiment, the first data source is static email configuration data 1002, which can include information such as SPF, DKIM, and TLS configuration settings associated with an email domain. The second data source can be live organizational data 1004, which provides real-time visibility into an organization's email traffic and mail flow information. The third data source can be external DMARC forensic data 1006, which monitors spoofing attempts and authentication results from external sources. The fourth data source can be aggregate reports 1008, which can include third-party reports and additional telemetry data.

In one example, the analysis engine 1010 receives and processes the static email configuration data 1002, live organizational data 1004, external DMARC forensic data 1006, and aggregate reports 1008 to generate a dynamic security score based on the combined inputs. In some aspects, the analysis engine 1010 can provide continuous compliance validation and a comprehensive perspective on an organization's email security posture. The system can enable the fusion of multiple data streams into a unified analysis that can detect misconfigurations, track configuration drift, identify threats, and generate security assessments for email environments.

The data aggregation and analysis system shown in FIG. 10 can integrate with the testing system 10 such as described in connection with FIGS. 1 and 2. In some embodiments, the static email configuration data 1002 can include the TLS, DKIM, SPF, and DMARC configuration information analyzed by the testing system such as described in connection with FIGS. 3 through 7. The live organizational data 1004 can include information derived from the test emails and reply emails transmitted and received by the testing system. The external DMARC forensic data 1006 can supplement the DMARC analysis described in connection with FIG. 7 by providing additional authentication results and spoofing attempt information from external sources. The aggregate reports 1008 can include IP reputation data and other third-party information used by the testing system to evaluate the security posture of an email domain. In this manner, the analysis engine 1010 can combine the individual security analyses performed by the methods described in FIGS. 3 through 9 with additional data sources to generate a comprehensive and dynamic security score that reflects the overall email security configuration of an organization.

In some embodiments, the analysis engine 1010 can perform proactive configuration drift monitoring by automatically running periodic tests of the configuration settings associated with the static email configuration data 1002. The analysis engine 1010 can detect misconfigurations and regressions over time, sometimes referred to as configuration drift, and can generate alerts when such drift is detected. In some aspects, the analysis engine 1010 can run nightly configuration tests and track trends in the configuration data over time. When a misconfiguration occurs, such as with SPF or DKIM settings, the analysis engine 1010 can generate a notification to allow for timely intervention before issues escalate into service degradation or security breaches.

Configuration drift can occur when the security settings of an email system change over time from a known or desired state. In some cases, configuration drift may result from administrative changes to email servers, updates to DNS records, certificate expirations, or modifications made during system maintenance. Configuration drift may also occur when third-party services integrated with an email system are updated or reconfigured. The negative impacts of configuration drift can include degraded email deliverability, increased vulnerability to spoofing and phishing attacks, authentication failures that cause legitimate emails to be rejected or marked as spam, and exposure of sensitive infrastructure information. In some aspects, configuration drift may go undetected for extended periods, during which the security posture of the email system may be compromised without the organization's knowledge. The analysis engine 1010 can address these concerns by providing automated monitoring that detects configuration drift and generates alerts, allowing organizations to maintain their email security configurations in a desired state.

In some embodiments, SPF configuration drift can occur when authorized sending servers are added to or removed from an organization's infrastructure without corresponding updates to the SPF record, when IP addresses of mail servers change, or when third-party email services are integrated or discontinued without modifying the SPF policy. DKIM configuration drift can occur when private keys are rotated without updating the corresponding public key in DNS records, when DKIM selectors are changed during server migrations, when certificates expire, or when email server software updates alter signing behavior. In some cases, SPF and DKIM drift may also result from DNS record propagation delays or errors introduced during manual record editing.

Early detection and correction of SPF and DKIM configuration drift can provide several benefits. In some aspects, timely identification of misconfigurations can prevent legitimate outbound emails from being rejected or marked as spam by receiving mail servers, thereby maintaining email deliverability and business communication continuity. Early correction can also reduce the window of opportunity for malicious actors to exploit authentication gaps for spoofing or phishing attacks. In some cases, proactive monitoring and alerting can reduce the support burden associated with troubleshooting email delivery issues after they have affected users. Additionally, maintaining properly configured SPF and DKIM records can support compliance with email authentication policies and can contribute to building and preserving domain reputation over time.

The live organizational data 1004 can provide real-time visibility into an organization's email traffic, enabling the analysis engine 1010 to detect new threats and behavioral anomalies as they occur. In some embodiments, the live organizational data 1004 can be obtained through integration with a mail security platform that processes email traffic for the organization. The analysis engine 1010 can analyze the live organizational data 1004 to identify patterns indicative of malicious activity, unusual traffic volumes, or other security-relevant events.

In some aspects, the availability of live organizational data in real-time can enable the analysis engine 1010 to respond to emerging threats more quickly than systems that rely on periodic or batch processing of email traffic information. Real-time visibility can allow for the detection of sudden changes in email traffic patterns, such as unexpected spikes in outbound message volume that may indicate a compromised account being used to send spam or phishing messages. In some cases, real-time monitoring can identify attempts to exfiltrate data through email channels by detecting unusual attachment sizes or frequencies. The live organizational data 1004 can also facilitate the identification of targeted attacks as they unfold, potentially allowing for intervention before significant damage occurs. In some embodiments, real-time data can support the correlation of events across multiple email accounts or domains within an organization, enabling the detection of coordinated attack patterns that might not be apparent when examining individual accounts in isolation. The immediacy of live data can also improve the accuracy of behavioral baselines by capturing current organizational email patterns, which can enhance the detection of deviations from normal activity. In some aspects, real-time visibility can support faster incident response by providing security personnel with current information about email traffic during an active investigation.

The integration of multiple data sources into the analysis engine 1010 can reduce the computational overhead associated with managing disparate security monitoring systems by consolidating analysis functions into a unified platform. In some aspects, the proactive detection of configuration drift and security anomalies can prevent system failures and reduce the processing burden that would otherwise result from responding to security incidents after they occur, thereby improving the overall efficiency and reliability of the electronic communication infrastructure.

The external DMARC forensic data 1006 can include forensic reports and aggregate reports received from external email service providers. These reports can provide information about spoofing attempts targeting the organization's domain, authentication failures observed by receiving mail servers, and other security-relevant data from sources external to the organization. In some aspects, the external DMARC forensic data 1006 can be processed by a modular DMARC processing layer within the analysis engine 1010 that can ingest, analyze, and enforce DMARC policy and telemetry data.

The aggregate reports 1008 can include third-party reports, IP reputation data, and additional telemetry data that supplements the other data sources. In some embodiments, the aggregate reports 1008 can include historical configuration trends, threat activity summaries, and security assessments from external providers.

In some aspects, the analysis engine 1010 can categorize alerts by severity and source, distinguishing between internal misconfigurations, traffic anomalies, and external spoofing attempts. The analysis engine 1010 can generate human-readable reports that summarize historical configuration trends, threat activity, and current security scores. These reports can be formatted for delivery to clients and can support both proactive communication when issues are detected and ongoing communication when the security posture is satisfactory.

In some embodiments, the system shown in FIG. 10 can support multi-tenant administration, allowing a managed service provider to manage multiple organizations from a single platform. The analysis engine 1010 can provide organization-specific visibility and alerts while normalizing email security posture across client domains for consistent monitoring and reporting.

The analysis engine 1010 provides improvements over conventional email security monitoring approaches by aggregating and correlating data from multiple distinct sources rather than analyzing each security dimension in isolation. Conventional systems may analyze configuration data, traffic patterns, and external authentication reports separately, which can result in fragmented visibility, delayed detection of security issues that span multiple data categories and require more resources. By fusing the static email configuration data 1002, live organizational data 1004, external DMARC forensic data 1006, and aggregate reports 1008 into a unified analysis, the analysis engine 1010 can identify relationships and patterns that may not be apparent when each data source is examined independently. For example, a configuration change detected in the static email configuration data 1002 can be correlated with authentication failures reported in the external DMARC forensic data 1006 to more quickly identify the root cause of email delivery issues.

The analysis engine 1010 can also improve the operation of the computer system by reducing the computational resources and administrative overhead associated with operating multiple separate security monitoring tools. In some aspects, consolidating analysis functions into a single platform can reduce memory consumption, processing cycles, and storage requirements compared to running independent monitoring systems for each data category. The unified architecture can also reduce network traffic by eliminating redundant queries to external data sources and by sharing common data structures across analysis functions. In some cases, the proactive detection of configuration drift and security anomalies can prevent cascading failures that would otherwise consume additional computational resources during incident response and remediation activities.

The analysis engine 1010 can further improve the operation of the message system by enabling faster detection and correction of issues that affect email deliverability and security. In some aspects, the combination of real-time traffic monitoring through the live organizational data 1004 with periodic configuration testing of the static email configuration data 1002 can reduce the time between when a misconfiguration occurs and when it is detected and corrected. This can minimize the duration during which legitimate emails may be rejected or marked as spam due to authentication failures. The integration of external DMARC forensic data 1006 can also improve the message system by providing visibility into how receiving mail servers are processing messages from the organization's domain, allowing for adjustments to authentication policies that can improve overall email deliverability and reduce the success rate of spoofing attempts targeting the organization.

The system can include automated deployment capabilities that improve the technology by reducing the likelihood of human error during initial configuration. Manual configuration of email security settings, including DNS records for SPF, DKIM, and DMARC, can be error-prone due to the complexity of the record syntax and the interdependencies between different authentication mechanisms. In some cases, typographical errors or incorrect formatting in manually entered DNS records can cause authentication failures that affect email deliverability. By automating the deployment of these configurations, the system can generate properly formatted records and deploy them consistently across organizations.

In some aspects, the automated deployment can also improve scalability for managed service providers administering email security for multiple client organizations. Rather than requiring manual configuration for each client domain, the system can programmatically provision security monitoring and authentication policies across multiple organizations from a single administrative interface.

The automated deployment can further improve the technology by enabling zero-touch configuration where possible, allowing security monitoring to begin immediately upon integration with the mail security platform. In some embodiments, the system can detect the email infrastructure associated with an organization and automatically configure appropriate monitoring parameters based on the detected configuration. This can reduce the delay between when an organization subscribes to the security service and when active monitoring begins, thereby minimizing the window during which the organization may be unprotected.

The system described herein is directed to a series of acts that can protect a computer or computer system from electronic communication that may contain malicious code of other undesirable content. The computerized system is one that is at least directed to a process. The system can identify and potentially isolate electronic messages in an electronic message system according to the edge value and/or the confidence values. The edge value and confidence values associated with a sender or electronic message can be stored in a database that can be accessible by a second analytical computer system that does not have to be in direct communications with the first analytical computer system. The processes and procedures that are described herein can be actuated by a compute processor that executes computer readable instructions to provide the functionality herein.

In some embodiments, the data aggregation and analysis system shown in FIG. 10 can operate as a standalone platform that independently monitors and analyzes email security configurations for one or more organizations. When deployed as a standalone system, the analysis engine 1010 can directly query DNS records, establish connections with mail servers, and retrieve configuration data without requiring integration with existing email infrastructure. The standalone configuration can be suitable for organizations that do not have existing security monitoring tools or that wish to supplement their current capabilities with dedicated email security analysis.

In some aspects, the system shown in FIG. 10 can be integrated with existing message monitoring systems to enhance their capabilities. The analysis engine 1010 can receive data feeds from existing security information and event management (SIEM) systems, email gateways, or other monitoring platforms. In such configurations, the live organizational data 1004 can be obtained from the existing monitoring infrastructure rather than requiring direct integration with the organization's mail servers. This can allow organizations to leverage their existing investments in security monitoring while gaining the benefits of the multi-source data aggregation and analysis provided by the analysis engine 1010.

In some cases, the system can operate in a hybrid mode where certain data sources are obtained through integration with existing systems while other data sources are collected directly by the analysis engine 1010. For example, an organization may have an existing mail security platform that provides the live organizational data 1004, while the static email configuration data 1002 and external DMARC forensic data 1006 are collected directly by the analysis engine 1010. This flexibility can allow the system to adapt to various deployment scenarios and organizational requirements.

The modular architecture of the data source module 1000 can facilitate integration with diverse existing systems by providing standardized interfaces for each data category. In some embodiments, adapters or connectors can be developed to translate data from existing monitoring systems into formats compatible with the analysis engine 1010, allowing the system to aggregate data from heterogeneous sources without requiring modifications to the existing infrastructure.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A system for analyzing an electronic communication system comprising:
a set of computer readable instructions stored in a tangible medium;
a data source module included in the computer readable instructions and in communication with an electronic message system and configured to receive data from a plurality of distinct data sources, the plurality of distinct data sources taken from the group of: static email configuration data associated with an email domain, live organizational data providing real-time visibility into email traffic associated with an organization; external DMARC forensic data including authentication results and spoofing attempt information from sources external to the organization; and aggregate reports including third-party reports and telemetry data;
an analysis engine in communication with the data source module and configured to receive the data from the plurality of distinct data sources, fuse the data from the plurality of distinct data sources into a unified analysis, generate a dynamic security score based on the unified analysis; and provide continuous compliance validation for the email domain; and,
wherein the analysis engine calculates a security score and generates a human-readable reports that summarize a historical configuration trend, a threat activity, and the security score.

2. The system of claim 1 wherein the static email configuration data including at least one of a SPF configuration settings, a DKIM configuration settings, and a TLS configuration settings.

3. The system of claim 1, wherein the analysis engine is further configured to perform proactive configuration drift monitoring by running periodic tests of the static email configuration data and detecting misconfigurations and regressions.

4. The system of claim 3, wherein the analysis engine is further configured to generate an alert when configuration drift is detected.

5. The system of claim 1, wherein the analysis engine is further configured to categorize alerts by a severity and a source, the source including at least one of internal misconfigurations, traffic anomalies, or external spoofing attempts.

6. The system of claim 1, wherein the analysis engine includes a modular DMARC processing layer configured to ingest, analyze, and enforce DMARC policy and telemetry data from the external DMARC forensic data.

7. The system of claim 1, wherein the system is configured to support multi-tenant administration, allowing management of a plurality of organizations from a single platform, and wherein the analysis engine is configured to provide organization-specific visibility and alerts while normalizing email security posture across client domains.

8. The system of claim 1, wherein the analysis engine is further configured to correlate a configuration change detected in the static email configuration data with authentication failures reported in the external DMARC forensic data to identify a root cause of email delivery issues.

9. The system of claim 1, further comprising automated deployment capabilities configured to automatically generate and deploy DNS records for at least one of SPF, DKIM, or DMARC associated with the email domain.

10. A system for monitoring email security configurations, comprising:
a processor;
a memory coupled to the processor and storing computer readable instructions that, when executed by the processor, cause the system to:
receive static email configuration data associated with an email domain, the static email configuration data including configuration settings for at least one of SPF, DKIM, or TLS;
receive live organizational data providing visibility into email traffic associated with an organization;
receive external DMARC data including authentication results from sources external to the organization;
aggregate the static email configuration data, the live organizational data, and the external DMARC data;
analyze the aggregated data to detect at least one of misconfigurations, configuration drift, or security threats; and
generate a security score based on the analysis of the aggregated data.

11. The system of claim 10, wherein the computer readable instructions further cause the system to perform proactive configuration drift monitoring by automatically running periodic tests of the static email configuration data and detecting regressions over time.

12. The system of claim 11, wherein the computer readable instructions further cause the system to generate an alert when configuration drift is detected, the alert being categorized by a severity and a source.

13. The system of claim 12, wherein the source includes at least one of internal misconfigurations, traffic anomalies, or external spoofing attempts.

14. The system of claim 10, wherein the computer readable instructions further cause the system to generate a human-readable report summarizing at least one of historical configuration trends, threat activity, or the security score.

15. The system of claim 10, wherein the computer readable instructions further cause the system to correlate a configuration change detected in the static email configuration data with authentication failures reported in the external DMARC data to identify a root cause of an email delivery issue.

16. A system for multi-source email security analysis, comprising:
a data aggregation module configured to:
collect static email configuration data associated with an email domain;
collect live mail flow data from an organization's email traffic; and
collect aggregate reports from external sources; and
an analysis engine in communication with a mail security platform configured to:
receive the static email configuration data, the live mail flow data, and aggregate reports from the data aggregation module;
correlate data across the static email configuration data, the live mail flow data, and aggregate reports to identify security issues; and
generate alerts categorized by a severity and a source based on the correlated data.

17. The system of claim 16, wherein the analysis engine is further configured to perform proactive configuration drift monitoring by automatically running periodic tests of the static email configuration data and detecting regressions over time.

18. The system of claim 16, wherein the analysis engine is further configured to generate a notification when configuration drift is detected, allowing for intervention before service degradation or security breaches occur.

19. The system of claim 16, wherein the analysis engine is further configured to generate human-readable reports summarizing historical configuration trends, threat activity, and current security scores for delivery to clients.

20. The system of claim 19, wherein the system is configured to support multi-tenant administration, allowing management of a plurality of organizations from a single platform, and wherein the analysis engine is configured to normalize email security posture across client domains for consistent monitoring and reporting.
